(19) United States
(12) Patent Application Publication
(10) Pub. No.: US 2004/0208515 A1
(43) Pub. Date: Oct. 21, 2004

(54) Signal to noise ratio measurement in a communications system

(76) Inventors: Edmund Walker, Loughton (GB); Timothy Large, Dunmow (GB)

Correspondence Address: William M. Lee, Jr., LEE, MANN, SMITH, MCWILLIAMS, SWEENEY & OHLSON, P.O. Box 2786, Chicago, IL, 60690-2786, US

(21) Appl. No.: 10/032,418

(22) Filed: Dec. 21, 2001

(51) Int. Cl. H04B 10/08; H04J 14/02

(52) U.S. Cl. 398/26

(57) ABSTRACT

The transmission properties of the signal carrier wavelengths in a wavelength division multiplexed optical transmission system are equalised with reference to their signal to noise ratios at a receiver. Each wavelength transmitter transmits a bit sequence as a modulation on the respective wavelength. At the receivers each wavelength modulated with the bit sequence is converted into a corresponding electrical signal. From a spectrum of that electrical signal, an electrical signal to noise ratio is determined. The measurements for the wavelengths are used to control adjustment of the individual wavelength transmitters such that the signal to noise ratios of the wavelengths are substantially equal.

### FIELD OF THE INVENTION

This invention relates to apparatus and methods for effecting signal to noise ratio measurement in an optical communications system. The invention further relates to apparatus and methods for the commissioning and performance monitoring of an optical communications system.

### BACKGROUND OF THE INVENTION

A major advance in the communications field has been the introduction of optical networks providing wavelength division multiplexed (WDM) transmission. For such systems a number different wavelengths share a common transmission path, including the system amplifiers, thus enhancing the effective capacity of the system.

A well-known problem with WDM systems is that of providing the various wavelengths with similar transmission properties at the receiver end of the system. This is a particular problem in a long-haul system with several amplifier stages when small differences between the transmission properties of the individual wavelengths become multiplied. There are a number of equalisation techniques available for resolving this problem, these techniques being dependent on the measurement of appropriate system parameters on initial set-up or during maintenance of the system. Frequently, equalisation schemes require the measurement and subsequent equalisation of OSNR (optical signal to noise ratio) at the end of the link. This parameter is used because it is readily measurable with field portable instrumentation and closely approximates receiver performance, which is limited by optical noise.

Measurement of optical signal to noise ratio is particularly difficult in systems with optical add/drop multiplexer (OADM) couplers. The difficulty of measuring accurately a typical optical signal to noise ratio (OSNR) of about 20 dB in 0.1 nm bandwidth is that the signal bandwidth at −20 dB from the signal peak is similar to the 3 dB OADM coupler bandwidth. As a consequence, there is an ill-defined noise shoulder present in the optical spectrum, which can result in significant over estimation of the OSNR of add/drop channels. The problem is exacerbated in so called glass-through systems when the add/drop channels are made express by ‘glassing through’ the OADM sites. In such systems, the express performance is critically dependent on the correct equalisation of the system, and this equalisation is in turn dependent on the accuracy of the OSNR measurement. At present, the only techniques available for OSNR measurement require the use of high cost optical spectrum analysers and provide results of doubtful accuracy Further, it is generally accepted that current techniques of OSNR measurement will become ineffective with the introduction of high-density OADM systems typically having 50 GHz channel spacing.

### OBJECT OF THE INVENTION

An object of the invention is to minimise or to overcome the above disadvantage.

A further object of the invention is to provide an improved method and apparatus for signal to noise ratio measurement in a wavelength division multiplexed communications system.

A further object of the invention is to provide an improved method of equalisation of a wavelength division multiplexed transmission system.

### SUMMARY OF THE INVENTION

According to a first aspect of the invention there is provided a method of measuring a signal to noise ratio of a received optical signal in an optical transmission system, the method comprising:

at an optical transmitter, transmitting a bit sequence;

at a receiver, receiving a wavelength modulated with the bit sequence, converting said received wavelength to a corresponding electrical signal, determining a spectrum for said electrical signal and determining an electrical signal to noise ratio for that received optical signal.

According to another aspect of the invention there is provided a method of equalising the transmission properties of a plurality of wavelengths in a wavelength division multiplexed optical transmission system comprising an optical transmitter, a receiver and a transmission path therebetween, the method comprising: at the transmitter, transmuting a bit sequence as a modulation on each said wavelength; at the receiver, receiving each said wavelength modulated with the pseudo-random bit sequence, converting that received wavelength to a corresponding electrical signal, determining a spectrum for said electrical signal and determining an electrical signal to noise ratio from that spectrum and, at the transmitter, adjusting the amplitude of each said transmitted wavelength such that the electrical signal to noise ratios of said wavelengths are substantially equal.

We have found unexpectedly that although the optical signal to noise ratio is not readily amenable to direct measurement, effective signal to noise ratio measurements can be made in the electrical domain. Further, we have found that there is a linear relationship between the electrical and optical signal to noise ratios and that measurement of the electrical signal to noise ration provides an effective basis for equalisation of the system.

The electrical signal to noise measurement and equalisation processes may be performed both on initial installation and commissioning of the communications system and during repair and maintenance operations.

Advantageously, the transmitter bit sequence is a pseudorandom bit sequence that is output by the transmitter in its default alarm inhibit signal (AIS) mode.

Adjustment of the amplitude of the transmitted wavelengths to achieve equalisation may be performed under the control of software via a computer or PC.

According to another aspect of the invention there is provided apparatus for equalising the transmission properties of a plurality of wavelengths in a wavelength division multiplexed optical transmission system comprising an optical transmitter arranged to transmit to a receiver a bit sequence as a modulation of each said wavelength, the apparatus comprising: spectrum analyser means disposed at the receiver and arranged to determine, from a spectrum of an electrical signal derived from a received optical signal for each wavelength, an electrical signal to noise ratio; and, means for adjusting the amplitude of each said transmitted wavelength such that the electrical signal to noise ratios of said wavelengths are substantially equal.

According to another aspect of the invention there is provided an optical receiver station for use in a wavelength division multiplexed optical transmission system, the receiver station comprising: a demultiplexer arranged to separate a received multiplexed signal into a plurality of individual wavelengths; receivers, one for each wavelength and arranged to convert that wavelength into a corresponding electrical signal; and electrical spectrum analyser means arranged to determine, from a spectrum of the electrical signal derived from each received optical wavelength, an electrical signal to noise ratio for that wavelength.

In a preferred embodiment, the transmission properties of the signal carrier wavelengths in a wavelength division multiplexed optical transmission system are equalised with reference to their signal to noise ratios at a receiver. Each wavelength transmitter transmits a bit sequence as a modulation on the respective wavelength. At the receiver, each wavelength modulated with the bit sequence is converted into a corresponding electrical signal. From a spectrum of that electrical signal, an electrical signal to noise ratio is determined. The measurements for the wavelengths are used to control adjustment of the individual wavelength transmitters such that the signal to noise ratios of the wavelengths are substantially equal.

### BRIEF DESCRIPTION OF THE DRAWINGS

An embodiment of the invention and the best known method of performing the invention will now be described with reference to the accompanying drawings in which:—

FIG. 1 is a schematic diagram of multi-wavelength optical regenerated (MOR) transmission system;

FIG. 2 shows the construction of a line amplifier and add/drop site used in the system of FIG. 1.

FIG. 3 shows a typical spectrum output at a demultiplexer monitor port in the system of FIG. 1;

FIG. 4 shows the construction of an optical signal to noise ratio (OSNR) measurement system according to a preferred embodiment of the invention;

FIG. 5 illustrates the electrical spectrum of a pseudo-random binary signal employed in the measurement system of FIG. 4, and

FIG. 6 is a graph showing the correlation between electrical and optical signal noise ratio in the measurement system of FIG. 4;

### DESCRIPTION OF PREFERRED EMBODIMENTS

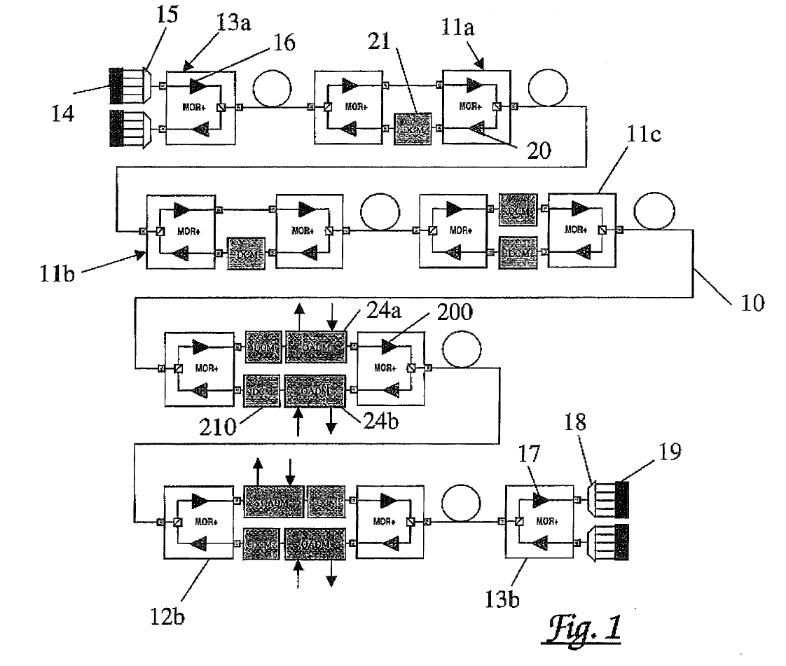

Referring first to FIG. 1, this shows in schematic form the construction of a multi-wavelength optical regenerator (MOR) fibre transmission system incorporating amplifier sites 11a, 11b, 11c and add/drop sites 12a, 12b disposed between terminal citations 13c, 13b and interconnected by fibre path 10. The system is bi-directional. Thus, each terminal station 13c, 13b incorporates on the transmitter side, a transmitter array 14, an input multiplexer 15 and a transmitter amplifier 16. On the receiver side, the terminal station incorporates a receiver amplifier 17, a receiver demultiplexer 18 and a receiver (photodiode) array 19.

Each amplifier station incorporates forward and reverse direction amplifiers 20 and one or more dispersion compensation modules 21 for the forward and/or reverse direction paths. Each add/drop site 12a, 12b incorporates forward and reverse direction amplifiers 200, dispersion compensator modules 210 and optical add/drop multiplexers 24a, 24b for the forward and reverse direction paths.

The system of FIG. 1 incorporates channels that provide add/drop access and so-called express channels that are carried direct from end to end with no intermediate add/drop traffic.

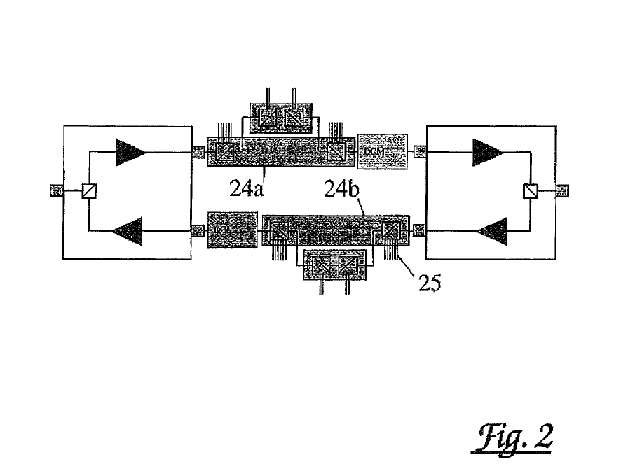

The construction of the add/drop site is shown in further detail in FIG. 2. As can be seen from this figure, both the forward and reverse paths are provided with respective optical add/drop multiplexers 24a, 24b, at each of which the individual wavelength channels are filtered into respective fibres 25. Depending upon the desired network configuration, these add/drop channels may be glassed through, i.e. the fibres can be looped back into the OADM, so that all channels appear at the receiver end of the system.

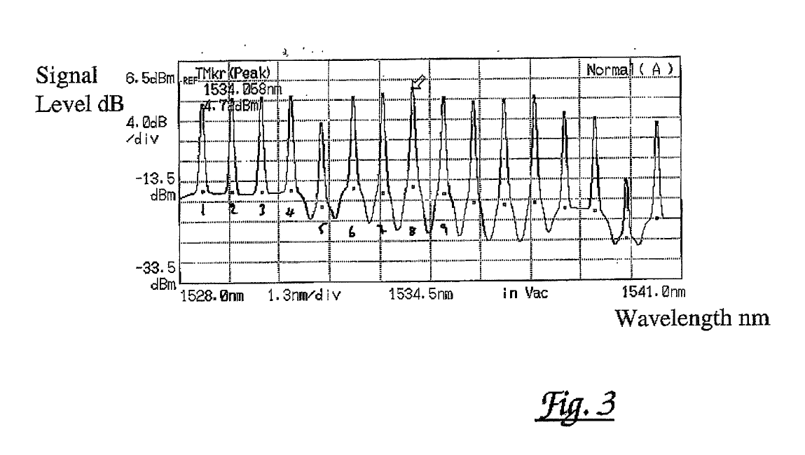

Referring to FIG. 3, this shows a typical optical spectrum at a receiver demultiplexer monitor port of the system of FIG. 1, where all of the add/drop channels have been glassed through. As can be seen from FIG. 3, the filtering properties of the optical add/drop multiplexers cause the filtering of the noise adjacent the add/drop and express channels.

Reading the graph of FIG. 3 from left to right, the two channel OADM wavelength correspond to peaks 5 and 15, and the six channel OADM wavelengths correspond to peaks 7 to 12. It will be noted that, for the majority of wavelengths depicted in FIG. 3, there is no clear noise floor that would provide a reference level for determination of the optical signal to noise ratio. This lack of accuracy makes the determination of equalisation settings for the system a difficult procedure.

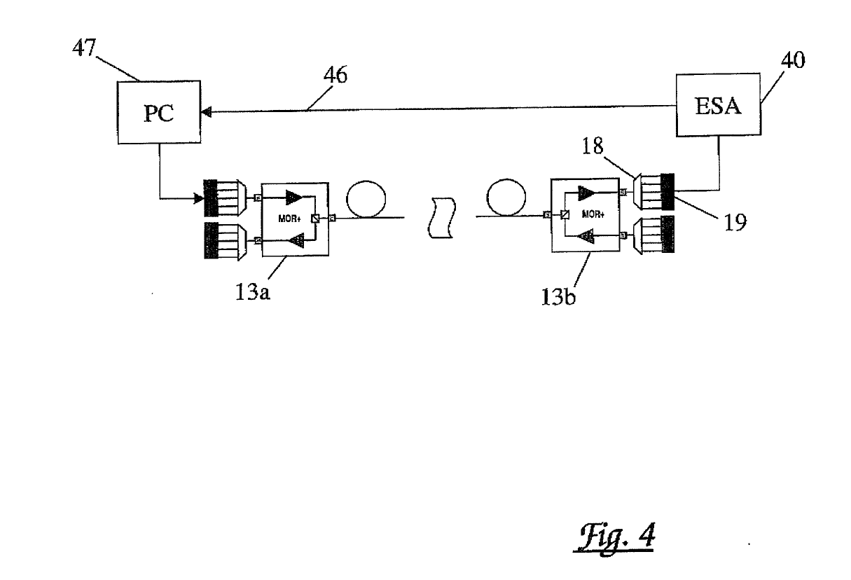

FIG. 4 shows an arrangement according to a preferred embodiment of the invention for determining the signal to noise ratio. For clarity, FIG. 4 shows only those parts of the system as are necessary for an understanding of the invention. In this arrangement, a signal to noise ratio measurement is determined for an electrical spectrum, As shown in FIG. 4, an electrical spectrum analyser (ESA) 40 is coupled to the respective wavelength outputs from the receiver demultiplexer at the terminal site 13b (FIG. 1). The electrical spectrum analyser converts the optically demultiplexed signal composing a single wavelength into an equivalent baseband electrical signal. The electrical spectrum analyser function is ideally incorporated in the receiver hardware in the form of an application specific integrated circuit.

For the purpose of this measurement, the transmitter at the terminal site 13a (FIG. 1) is operated in its alarm inhibit signal (AIS) mode. This is a default mode for a communications network optical transmitter in which the transmitter produces a finite pattern length pseudo-randon bit sequence (PRBS). Typically a 2⁷ bit sequence is employed.

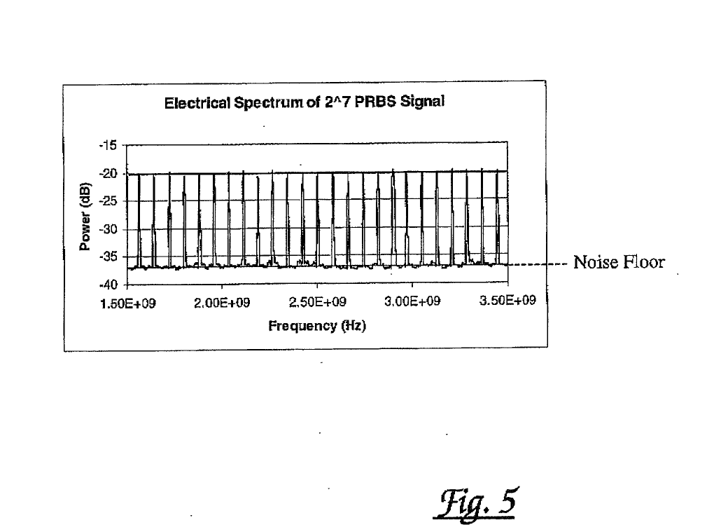

The electrical spectrum of the received pseudo-random bit sequence is shown in FIG. 5. As can be seen, this spectrum comprises a series of substantially similar peaks with a clearly defined noise floor.

The dominant noise source is signal-spontaneous beat noise which results from mixing of the optical signal and amplified spontaneous emission (ASE) within the signal bandwidth. This beat noise is uncorrelated with the signal and thus appears in FIG. 5 as a noise floor between the spectrum peaks of the pseudorandom bit sequence. This clear delineation between the noise and the signal allows an accurate determination of the electrical signal to noise ratio to be made.

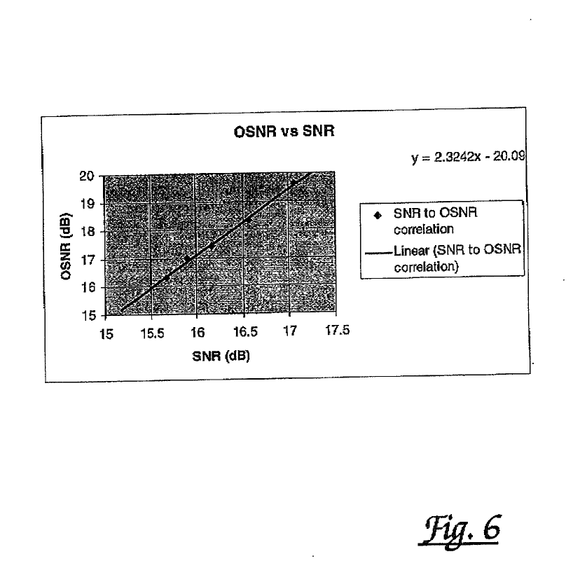

It can be demonstrated that the resulting electrical signal to noise ratio can be directly correlated with the optical signal to noise ratio, which is used in prior art as the measurement of channel quality. The calculation is illustrated by the graph of FIG. 6 which shows the typical linear relationship between the electrical and optical signal to noise ratio for an express wavelength. The optical signal to noise ratio may be calculated from the electrical signal to noise ratio by determining the slope and intercept of the graph. Thus, in the example given in FIG. 6, the optical signal to noise ratio (OSNR) is calculated from the electrical signal to noise ratio (SNR) as

OSNR=2.32*SNR−20.09

Referring again to FIG. 4, the system is equalised by determining the electrical signal to noise ratio for each transmitted wavelength, followed by adjustment of the transmitters for the respective wavelength such that the signal to noise ratios of the respective wavelengths are substantially equal. This adjustment may be effected manually or, advantageously, via a feedback loop 46 from the spectrum analyser 40 to a computer (PC) 47 controlling the amplitude of each transmitted wavelength. Determination of the electrical signal to noise ratio, from the noise floor and peak values of the spectrum may be effected either by the spectrum analyser 40 or by the PC 47, The process is employed in the initial set-up and the commissioning of a newly installed system, and during maintenance and upgrade operations.

It will be understood that the above description of a preferred embodiment is given by way of example only and that various modifications may be made by those skilled in the art without departing from the spirit and scope of the invention.

1. A method of measuring a signal to noise ratio of a received optical signal in an optical transmission system, the method comprising:
at an optical transmitter, transmitting a bit sequence;
at a receiver, receiving a wavelength modulated with the bit sequence, converting said received wavelength to a corresponding electrical signal, determining a spectrum for said electrical signal and determining an electrical signal to noise ratio from said spectrum for that received optical signal.

2. A method as claimed in claim 1, wherein the transmission system has one or more optical add/drop sites.

3. A method as claimed in claim 2, wherein said transmitter is operated in an alarm inhibit signal mode so as to generate a pseudorandom bit sequence.

4. A method as claimed in claim 3, wherein said pseudorandom bit sequence comprises a 2⁷ bit sequence.

5. Software in machine readable form on a storage medium and arranged to perform a method as claimed in claim 1.

6. A method of equalising the transmission properties of a plurality of wavelengths in a wavelength division multiplexed optical transmission system comprising an optical transmitters a receiver and a transmission path therebetween, the method comprising:
at the transmitter, transmitting a bit sequence as a modulation on each said wavelength;
at the receiver, receiving each said wavelength modulated with the bit sequence, converting that received wavelength to a corresponding electrical signal, determining a spectrum for said electrical signal and determining from that spectrum an electrical signal to noise ratio, and,
at the transmitter, adjusting the amplitude of each said transmitted wavelength such that the calculated electrical signal to noise ratios of said wavelengths are substantially equal.

7. A method as claimed in claim 6, wherein the transmission system has one or more optical add/drop sites.

8. A method as claimed in claim 7, wherein said transmitter is operated in an alarm inhibit signal mode so as to generate a pseudorandom bit sequence.

9. A method as claimed in claim 8, wherein said pseudorandom bit sequence comprises a 2⁷ bit sequence.

10. Software in machine readable form on a storage medium and arranged to perform a method as claimed in claim 6.

11. Apparatus for equalising the transmission properties of a plurality of wavelengths in a wavelength division multiplexed optical transmission system comprising an optical transmitter arranged to transmit to a receiver a bit sequence as a modulation of each said wavelength, the apparatus comprising:
spectrum analyser means disposed at the receiver and arranged to determine, from a spectrum of an electrical signal derived from a received optical signal for each wavelength, an electrical signal to noise ratio; and,
means for adjusting the amplitude of each said transmitted wavelength such that the calculated optical signal to noise ratios of said wavelengths are substantially equal.

12. Apparatus as claimed in claim 12, wherein the transmission system has one or more optical add/drop sites.

13. An optical transmission system incorporating equalisation apparatus as claimed in claim 13.

14. An optical receiver station for use in a wavelength division multiplexed optical transmission system, the receiver station comprising: a demultiplexer arranged to separate a received multiplexed signal into a plurality of individual wavelengths; receivers, one for each wavelength and arranged to convert that wavelength into a corresponding electrical signal; and electrical spectrum analyser means arranged to determine, from a spectrum of the electrical signal derived from each received optical wavelength, an electrical signal to noise ratio for that wavelength.
